(19) United States
(12) Patent Application Publication
(10) Pub. No.: US 2002/0153866 A1
(43) Pub. Date: Oct. 24, 2002

(54) Electronic data processor with a plug-and-charge device

(76) Inventor: Chien-Yuan Huang, Taipei (TW)

Correspondence Address: BIRCH STEWART KOLASCH & BIRCH, PO BOX 747, FALLS CHURCH, VA, 22040-0747, US

(21) Appl. No.: 09/836,215

(22) Filed: Apr. 18, 2001

(51) Int. Cl. H02J 7/04; H02J 7/16

(52) U.S. Cl. 320/162

(57) ABSTRACT

The present invention pertains to an electronic data processor with a plug-and-charge device, which the plug-and-charge device is directly connected to local supplying power so as to recharge a rechargeable battery located inside the electronic data processor. The present invention designs an electric linking unit capable of connecting with an interior system-power-supplying unit in system and capable of connecting with outside local supplying power. The electric linking unit is also able to adjust the voltage of the local supplying power to fit the work voltage of the rechargeable battery and then achieve the job of charging.

### BACKGROUND OF THE INVENTION

1. Field of Invention

The present invention relates to an electronic data processor with a plug-and-charge device, which is applied in the fields of cellular phone, PDA (Personal Digital Assistant). HPC (Hand-held PC), and so on. The present invention provides a function of direct connection to local supplying power so as to recharge the battery to supply the energy of electricity.

2. Related Art

Some portable and personalized digital products, such as cellular phones, PDAs and HPCs, individually have functions of communication, data management and data processing. These personalized digital products make remote communication easier and provide electric assistance and information management.

The personalized digital products described above usually own a variety of powerful functions. But no matter how powerful the functions are, these personalized digital products have to rely on electricity to work normally. Due to the personalized digital products are made portable for the convenience of users, so almost each of them has a rechargeable battery equipped in the mechanism body. The rechargeable battery is able to supply the energy of electricity to the personalized digital products. When the energy of electricity is run out, the rechargeable battery is capable of being used again after recharging itself.

Present available personalized digital products. such like cellular phones. adopt separated design to their batteries. in other words. In other words, their rechargeable batteries are able to be removed alone from the products body and then be recharged by chargers, or the batteries still stay in the cellular phones and are recharged by transformers. As to the batteries of PDAs are usually fixed inside, so their rechargeable batteries are not able to be taken out. PDAs are usually charged directly by transformers.

In short, present available personalized digital products all need a kind of assistant tool, such as chargers or transformers, to do the job of charging. If users would like to go outside for a long term like having business trips or travel, they have to carry chargers or transformers for avoiding their batteries running out and not being able to use theirs personalized digital products any more. But the chargers or transformers usually occupy certain space. If the connecting wires are also considered, the chargers or transformers are not convenient for carrying with ones. However, it is also a big problem for users that if the electricity of batteries is run out and they do not carry any backup battery or charger.

### SUMMARY OF THE INVENTION

In view of the foregoing, it is an object of the invention to provide an electronic data processor with a plug-and-charge device, which is used to directly connect the electronic data device with local supplying power so as to charge the rechargeable battery located inside.

Pursuant to the above-mentioned object, the invention designs an electric linking unit capable of connecting with an interior system-power-supplying unit in system and capable of connecting with outside local supplying power. The electric linking unit is also able to adjust the voltage of the local supplying power to fit the work voltage of the rechargeable battery and then does the job of recharging. When the electricity power of the rechargeable battery is going to run out, users just need to find out the position of outlets of local supplying power and directly connect the electric linking unit of electronic data processor with one of the outlets so as to make the job of charging

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 depicts a schematic view of the function structure of the present invention.

FIG. 2 depicts a schematic view of the appearance of the present invention.

FIG. 3A and FIG. 3B show schematic view of the plug's action of the present invention.

FIG. 4 depicts a schematic view of another embodiment of the present invention.

### DETAILED DESCRIPTION OF THE INVENTION

According to the electronic data processor with a plug-and-charge device disclosed by the present invention, which lets the electronic data processor is able to directly connect with local supplying power so as to charge the rechargeable battery that provides energy of electricity. Wherein the electronic data processor is one of cellular phone, PDA (Personal Digital Assistant), HPC (Hand-held PC), and so on. These electronic data processors are able to provide the functions of one-to-one communication, data processing and data storing.

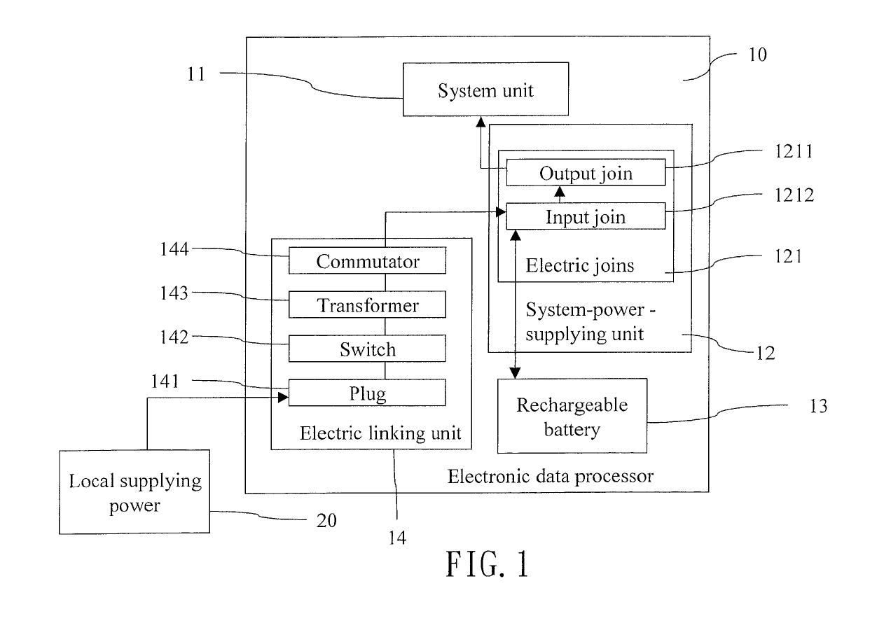

Referring to FIG. 1, according to the electronic data processor with a plug-and-charge device disclosed by the present invention 10, which includes a system unit 11, a system-power-supplying unit 12, a rechargeable battery 13 and an electric linking unit 14.

The system unit 11 consists of various electronic components and circuits so as to execute some setting functions. The setting functions, which include the technologies of communication, data processing and data storing, achieved by the electronic data processor such as cellular phone, PDA and HPC, are quite common to one skilled in the art, so the present invention does not describe the detail of above-mentioned technologies here.

The system-power-supplying unit 12 has an electric connection with the system unit 11. There is a plurality of electric joins 121 in the system-power-supplying unit 12. The electric joins 121 are further divided into an output join 1211 and an input join 1212. Wherein, the output join 1211 has an electric connection with the system unit 11 and the input join 1212 separately connects with the rechargeable battery 13 and the electric linking unit 14.

The rechargeable battery 13 is a kind of battery that can be used again after recharging. The rechargeable battery 13 has an electric connection with the input join 1212 so as to provide the energy of electricity that the system unit 11 needs. When the electricity of the rechargeable battery 13 is going to run out, the rechargeable battery 13 is able to be taken out alone and be charged isolatedly by a charger (is not shown in the figure), or be charged through the electric linking unit 14.

The electric linking unit 14 has an electric connection with the input join 1212. The electric linking unit 14 consists of a plug 141, a selecting switch 142, a transformer 143 and a commutator 144. Wherein, the selecting switch 142 is able to shift the voltage which is going to be transformed according to the value of local supplying power 20 (for example: 110 V or 220 V). The plug 141 is used to directly connect with local supplying power 20. The transformer 143 is used to change the voltage of local supplying power 20 to fit the voltage of the rechargeable battery 13. The commutator 144 is used to provide the need of rectification, for example: turning alternating current into direct current. Therefore, the electric linking unit 14 utilizes the plug 141 to form a direct electric connection with local supplying power 20 and adjusts the voltage of the local supplying power 20 to fit the work voltage of the rechargeable battery 13 through the transformer 143 and the commutator 144 and then achieves the job of charging.

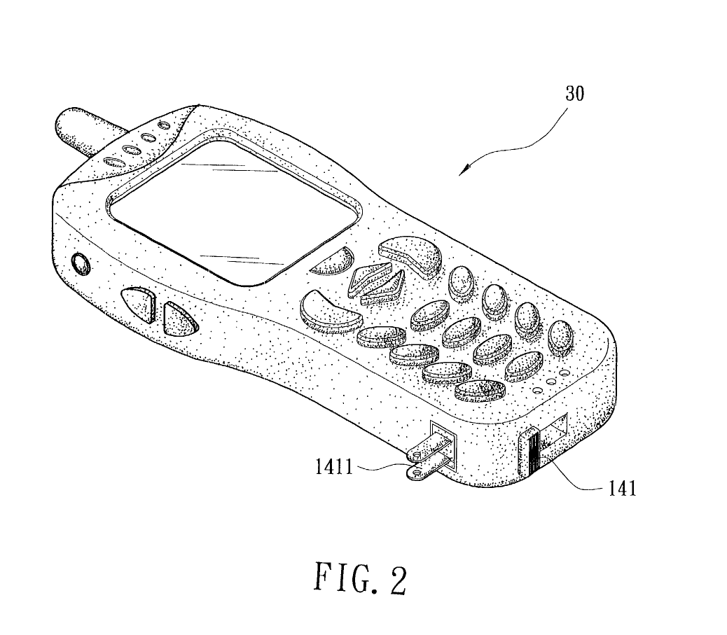

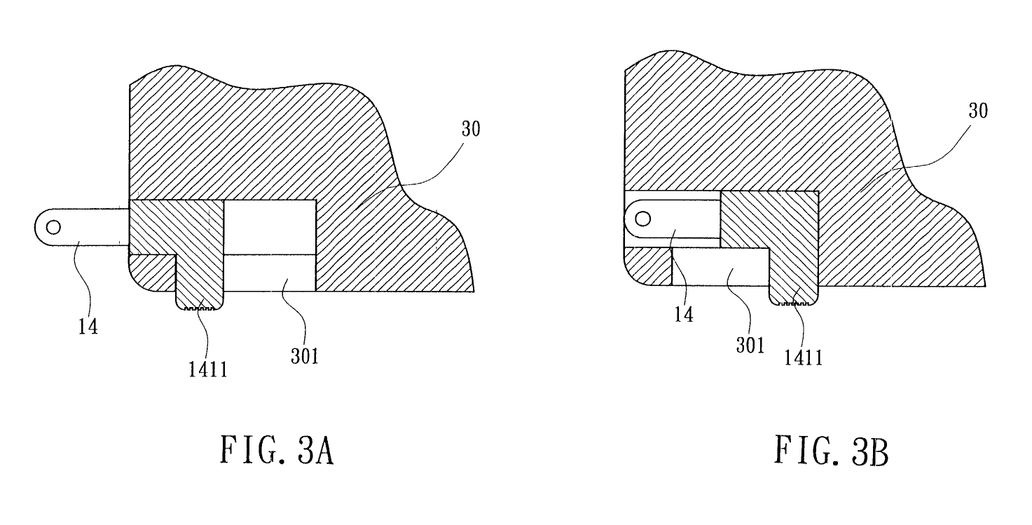

Referring to FIG. 2, it is an embodiment that the present invention is applied in cellular phone 30. Wherein, there is a containing slot 31 in the cellular phone 30. The plug 141 of the electric linking unit 14 is set in the containing slot 31 with an activable relationship. The containing slot 31 at least has a hiding position which is able to hide the plug 141 in the containing slot 31 and a charging position which lets the plug 141 stretch out the containing slot 31 to connect with local supplying power 20, as shown in FIG. 3A and FIG. 3B. The plug 141 is able to move between the hiding position and the charging position in a straight way. Moreover, the plug 141 further comprises a pushing button 1411 which is exposed out of the containing slot 31 so as to let users control the plug's moving between the hiding position and the charging position.

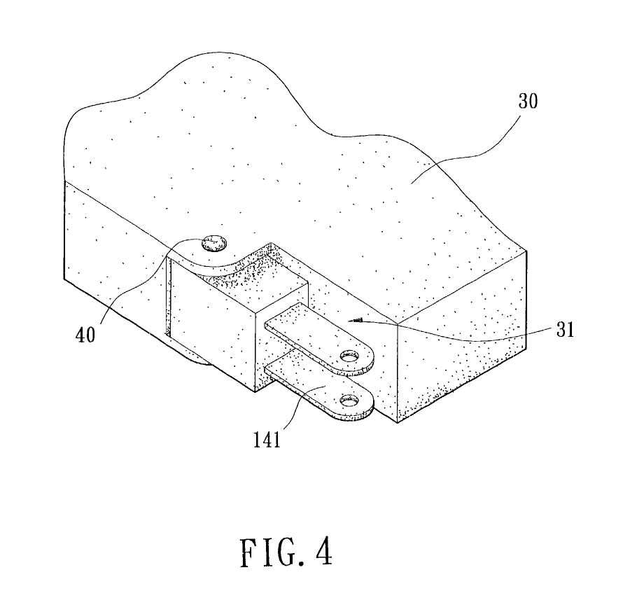

Referring to FIG. 4, it is another embodiment that how the plug 141 gets a link with the containing slot 31. Wherein, the plug 141 utilizes a pivot 40 which is set inside the containing slot 131 with a rotative relationship to let the plug move in a rotative way between the hiding position and the charging position.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### Effects Achieved by the Present Invention

According to the electronic data processor with a plug-and-charge device disclosed by the present invention, when the electricity of the battery of the electronic data processor is going to run out, all users need to do is find out the position of outlets of local supplying power. Then users just directly connect the electric linking unit of electronic data processor with one of the outlets and achieve the job of charging.

What is claimed is:

1. An electronic data processor with a plug-and-charge device which is able to directly connect with local supplying power, the processor comprising:
a system unit, which is used to execute or process electronic data;
a rechargeable battery, which provides the energy of electricity to the system unit;
a system-power-supplying unit, which is connected to both of the system unit and the rechargeable battery in order to let the rechargeable battery supply the needing electricity to the system unit through the system-power-supplying unit; and
a electric linking unit, which is connected with the system-power-supplying unit and capable of being directly connected with local supplying power and is used to adjust the voltage of local supplying power to fit the work voltage of the rechargeable battery so as to charge the rechargeable battery.

2. The processor of claim 1, wherein the system unit consists of various electronic components and circuits so as to execute setting functions.

3. The processor of claim 1, wherein the rechargeable battery is capable of being taken out from the electronic data processor and being charged alone by a charger.

4. The processor of claim 1, wherein the system-power-supplying unit has a plurality of electric joins, which at least comprises an input join that has an electric connection with the rechargeable battery and an output join that has an electric connection with the system unit so as to transmit the energy of electricity from the rechargeable battery to the system unit.

5. The processor of claim 1, wherein the electric linking unit further comprises:
a plug, which is used to connect with local supplying power;
a transformer, which is used to change the voltage of local supplying power to fit the voltage of the rechargeable battery;
a selecting switch, which is used to shift the voltage's value of the transformer to correspond with the local supplying power; and
a commutator, which is used to provide the need of rectification, for example: turning alternating current into direct current.

6. The processor of claim 5, wherein the electric linking unit further provides a containing slot to hide the plug.

7. The processor of claim 6, wherein the plug is set in the containing slot with an activable relationship and the containing slot at least has a hiding position which is able to hide the plug in the containing slot and a charging position which lets the plug stretch out to connect with local supplying power.

8. The processor of claim 6, wherein the plug moves between the hiding position and the charging position in a straight way.

9. The processor of claim 8, wherein the plug further comprises a pushing button which is exposed out of the containing slot so as to control the plug moving in a straight way between the hiding position and the charging position.

10. The processor of claim 6, wherein the plug moves between the hiding position and the charging position in a rotative way.

11. The processor of claim 10, wherein the plug further comprises a pivot which is set inside the containing slot and a pushing button which is exposed out of the containing slot so as to control the plug moving in a rotative way between the hiding position and the charging position.
